(19) United States
(12) Patent Application Publication
(10) Pub. No.: US 2013/0136975 A1
(43) Pub. Date: May 30, 2013

(54) BATTERY DEVICE

(71) Applicant: Masataka Uchida, Tokyo (JP)

(72) Inventor: Masataka Uchida, Tokyo (JP)

(73) Assignee: MITSUBISHI HEAVY INDUSTRIES, LTD., Tokyo (JP)

(21) Appl. No.: 13/814,862

(22) PCT Filed: Sep. 14, 2011
(86) PCT No.: PCT/JP2011/070968

§ 371 Date: Feb. 7, 2013

(30) Foreign Application Priority Data
Sep. 16, 2010 (JP) 2010-208428

(51) Int. Cl. H01M 2/10

(52) U.S. Cl. CPC H01M 2/1077
USPC 429/159

(57) ABSTRACT

A battery device including a plurality of unit cells that include a pair of electrode terminals, a casing main body that includes an opening portion and a top plate that closes an upper portion, and that accommodates insertion of the unit cells from the opening portion while the pair of electrode terminals faces upward, a temporary pressing portion, a terminal connection member that abuts the pair of electrode terminals of the unit cell that is accommodated in the casing main body, and electrically connects the electrode terminals of the unit cells adjacent to each other, and a cover portion that includes a battery biasing member that biases the unit cell upward in a state where the opening portion is closed and makes the electrode terminals abut the terminal connection member, and that is provided so as to be opened and closed in the opening portion.

### TECHNICAL FIELD

The present invention relates to a battery device that is installed to a vehicle that is driven using electric power, a power storage apparatus, a UPS (uninterruptible power supply), or the like.

Priority is claimed on Japanese Patent Application No. 2010-208428, filed Sep. 16, 2010, the content of which is incorporated herein by reference.

### BACKGROUND ART

In recent years, from a viewpoint of a low environmental impact, energy other than petroleum resources, and the like, automobiles that have an electric motor as a drive source have attracted attention. A battery device is installed so as to accumulate electric energy in such automobiles (for example, refer to Patent Document 1).

The battery device is disposed on a floor that is mounted between front wheels and rear wheels of four wheels included in the automobile in the lower portion of the automobile, and the battery device is configured of a plurality of battery main bodies (unit cells).

In general, the battery main bodies are mounted so as to be attachable to and detachable from the floor so that electrode terminals electrically connected to the battery main bodies face upward. Bus bars (terminal connection members) for performing electrical connection between the battery main bodies are mounted between electrode terminals of each of the battery main bodies, and the electric energy that is accumulated in each of the battery main bodies is supplied to a motor that is included in an electric automobile through the bus bars. In addition, after the battery main body discharges useable electric power or reaches the end of a service life, the battery main bodies are exchanged with new ones.

### PRIOR ART DOCUMENTS

### Patent Documents

Patent Document 1: Japanese Registered Utility Model No. 2593329

### SUMMARY OF INVENTION

### Problem to be Solved by the Invention

However, in the above-described electric automobile, besides bus bars that are connected to electric terminals of battery main bodies in the peripheries of the battery main bodies, various parts for preventing short circuits of the electric terminals or for separating the battery main bodies from passengers are provided. Thereby, when the battery main bodies are exchanged, various parts or the bus bars need to be removed from the battery main bodies, and the work is complicated.

In addition, when new battery main bodies are mounted, the electric terminals of the battery main bodies need to be reliably connected to bus bars in order to reliably supply the electric energy that is accumulated in the battery main bodies to the motor.

In addition, also in a power storage apparatus, a UPS (uninterruptible power supply), or the like, as described above, besides bus bars that are connected to electric terminals of battery main bodies in the peripheries of the battery main bodies, various parts for preventing short circuits of the electric terminals are provided, and therefore, when the battery main bodies are exchanged, various parts or the bus bars need to be removed from the battery main bodies, and the work is complicated.

The present invention is made in consideration of the above-described problems, and an object thereof is to provide a battery device capable of being easily attached and detached and reliably connecting electrode terminals of unit cells to terminal connection members when unit cells are attached to and detached from a vehicle, a power storage apparatus, a UPS (uninterruptible power supply), or the like.

### Means for Solving the Problem

A battery device of the present invention includes a plurality of unit cells that include a pair of electrode terminals that protrudes from one end surface; a casing main body that includes an opening portion that is formed in a lower portion and a top plate that closes an upper portion, and that accommodates insertion of the unit cells from the opening portion while the pair of electrode terminals faces upward; a temporary pressing portion that can support the unit cells in a state where the unit cells are accommodated in the casing main body; a terminal connection member that is provided in an inner surface of the top plate, abuts the pair of electrode terminals of the unit cell that is accommodated in the casing main body, and electrically connects the electrode terminals of the unit cells adjacent to each other; and a cover portion that includes a battery biasing member that biases the unit cell upward in a state where the opening portion is closed and makes the electrode terminals abut the terminal connection member, and that is provided so as to be opened and closed in the opening portion.

According to this invention, when the unit cell is mounted to the casing main body, first, the unit cell is inserted upward from the opening portion that is formed in the lower portion of the casing main body while the electrode terminals face upward. Subsequently, since the unit cell is supported by the temporary pressing portion, the state where the unit cell is accommodated in the casing main body can be held. At this time, an operator can accommodate the unit cell in the casing main body by supporting only the unit cell.

In addition, the opening portion of the casing main body is closed by the cover portion while the unit cell is biased upward by the battery biasing member. Thereby, unlike the related art, without attaching or detaching of the bus bar to or from the electrode terminals of the battery main body, the electrode terminals can abut the terminal connection member due to the biasing force of the battery biasing member, and the electric terminals and the terminal connection member can be reliably connected to each other. In addition, when the cover portion is mounted to the casing main body, since the unit cell is supported by the temporary pressing portion, the operator can perform a mounting operation of the cover portion without supporting a weight of the unit cell.

On the other hand, when the unit cell is removed from the casing main body, since the unit cell is supported by the temporary pressing portion even when the cover portion is removed from the casing main body, the unit cell does not drop downward. In addition, since the electrode terminals only abut the terminal connection member, the unit cell can be removed from the casing main body by only releasing the supporting state of the temporary pressing portion.

Therefore, the unit cell can be easily attached to and detached from the casing main body.

Moreover, in the battery device, it is more preferable that the temporary pressing portion be provided so as to move to a supporting position that can support the unit cell accommodated in the casing main body and a retreat position at which the unit cell can be inserted into and removed from the casing main body through the opening portion.

According to this invention, due to the fact that the temporary pressing portion is disposed at the retreat position, the unit cell can be easily inserted into and removed from the casing main body through the opening portion. On the other hand, due to the fact that the temporary pressing portion is disposed at the supporting position, the unit cell that is inserted into the casing main body may be supported in a state of being accommodated in the casing main body.

In addition, in the battery device, it is more preferable that the casing main body further include a pressing portion biasing member that biases the temporary pressing portion to be disposed at the supporting position.

According to this invention, after moving the temporary pressing portion from the supporting position up to the retreat position against the biasing force of the pressing portion biasing member, the unit cell is inserted into the casing main body through the opening portion. When the unit cell is accommodated in the casing main body, since the temporary pressing portion is returned to the supporting position by the biasing force of the pressing portion biasing member, the unit cell can be easily supported by the temporary pressing portion.

Moreover, in the battery device, it is more preferable that the temporary pressing portion include an inclined surface that is formed so as to move from the supporting position side toward the retreat position side as the unit cell moves from the lower portion toward the upper portion.

According to this invention, when the unit cell is inserted into the casing main body through the opening portion, since the unit cell abuts the inclined surface and is inserted while sliding, the temporary pressing portion can move from the supporting position to the retreat position. By carrying out only the operation which inserts the unit cell, the temporary pressing portion moves to the retreat position, the unit cell is inserted into the casing main body, and the unit cell can be supported by the temporary pressing portion in the state where the unit cell is accommodated in the casing main body.

In addition, in the battery device, it is more preferable that the pair of electrode terminals has mutually different lengths that protrude from the one end surface of the unit cell.

According to this invention, when the unit cell is accommodated in the casing main body in a state where mutual positions of a pair of electrode terminals are exchanged, the other electrode terminal in which the length protruding from the one end surface is longer abuts the terminal connection member of a portion which one electrode terminal, in which the length protruding from the one end surface is shorter in the pair of electrode terminals, is originally abutted, and the one electrode terminal is separated from the terminal connection member.

Thereby, since the unit cell cannot be inserted up to a predetermined position in the casing main body, it is possible to prevent the unit cells from being incorrectly mounted to the casing main body in the state where the positions of the pair of electrode terminals are exchanged.

In addition, in the battery device, it is more preferable that a protrusion that is provided so as to protrude from the one end surface be formed and a recessed portion into which the protrusion is inserted be formed in an inner surface of the top plate of the casing main body.

According to this invention, when the unit cell is accommodated in the casing main body in the state where the mutual positions of the pair of electrode terminals are exchanged, the protrusion of the unit cell abuts the inner surface of the top plate of the casing main body, and the unit cell cannot be inserted up to a predetermined position in the casing main body.

Therefore, it is possible to prevent the unit cells from being incorrectly mounted to the casing main body in the state where the positions of the pair of electrode terminals are exchanged.

Moreover, in the battery device, it is more preferable that the battery device further include a cover member that is fitted to the unit cell and includes a convex portion that protrudes from a side surface of the unit cell, and a groove portion that engages with the convex portion of the unit cell accommodated in the inner portion of the casing main body and can move up and down be formed in an inner circumferential surface of the casing main body.

According to this invention, when the unit cell is inserted into the casing main body in a direction different from a general insertion direction, since the convex portion included in the cover member abuts the casing main body, the unit cell cannot be inserted up to a predetermined position in the inner portion of the casing main body. Therefore, it is possible to prevent the unit cell from being incorrectly mounted to the casing main body in the direction different from the general insertion direction. In addition, since the convex portion is formed in the cover member, the shape of the cover member that is fitted to the unit cell may be changed even when the shapes of the unit cells are the same as one another, which can correspond to various shapes of the groove portion.

### Advantageous Effects of Invention

According to the battery device of the present invention, the unit cell can be easily attached and detached, and the electrode terminals of the unit cell can be reliably connected to the terminal connection member.

### BRIEF DESCRIPTION OF DRAWINGS

FIG. 1 is a side view in which a portion of an automobile, to which a battery device of a first embodiment of the present invention is installed, is removed.

FIG. 2 is a bottom view in which a portion of a main portion of the automobile is transparent.

FIG. 3 is a cross-sectional view taken along a cut line A1-A1 in FIG. 2.

FIG. 4 is a perspective view in which a portion of a unit cell of the battery device is removed.

FIG. 5 is a cross-sectional view taken along a cut line A2-A2 in FIG. 3.

FIG. 6 is an enlarged view of B in FIG. 5.

FIG. 7 is a bottom view in which parts of a main portion of the automobile are omitted.

FIG. 8 is a view that explains a procedure in which the unit cells of the battery device are exchanged.

FIG. 9 is a view that explains a procedure in which the unit cells of the battery device are exchanged.

FIG. 10 is a bottom view which parts of a main portion in a battery device according to a second embodiment of the present invention are omitted.

FIG. 11 is a cross-sectional view taken along a cut line A3-A3 in FIG. 10.

FIG. 12 is a cross-sectional view of a main portion in a battery device according to a third embodiment of the present invention.

FIG. 13 is a cross-sectional view of a main portion in a battery device of a modification of an embodiment of the present invention.

FIG. 14 is a cross-sectional view taken along a cut line A4-A4 in FIG. 13.

FIG. 15 is a cross-sectional view of a main portion in a battery device of a modification of an embodiment of the present invention.

FIG. 16 is a cross-sectional view taken along a cut line A5-A5 in FIG. 15.

FIG. 17 is a cross-sectional view of a main portion in a battery device of a modification of an embodiment of the present invention.

FIG. 18 is an explanatory view showing a disposition of a terminal connection member in a battery device of a modification of an embodiment of the present invention.

### MODE FOR CARRYING OUT THE INVENTION

### First Embodiment

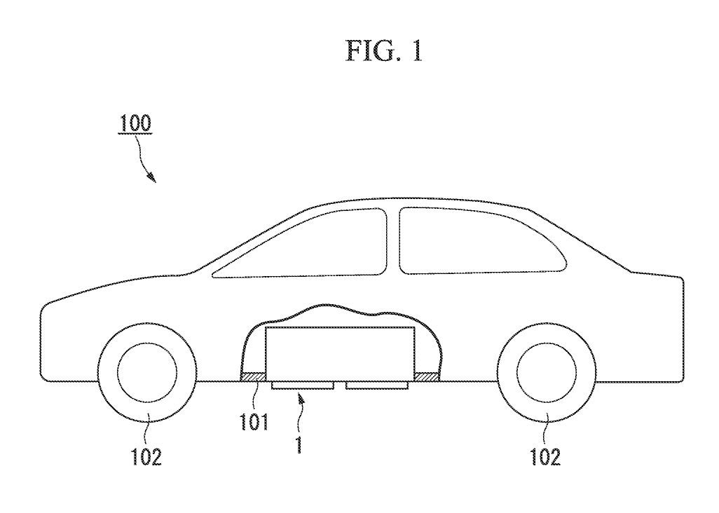

Hereinafter, an automobile, in which a first embodiment of a battery device according to the present invention is installed, will be described with reference to FIGS. 1 to 9.

As shown in FIG. 1, a battery device 1 of the present embodiment is mounted on an undercarriage 101 of an automobile 100. A motor (not shown) is included in the automobile 100 and the battery device 1 is electrically connected to the motor. In addition, electric energy is supplied from the battery device 1 to the motor, and therefore, wheels 102 are rotated and the automobile 100 can be driven.

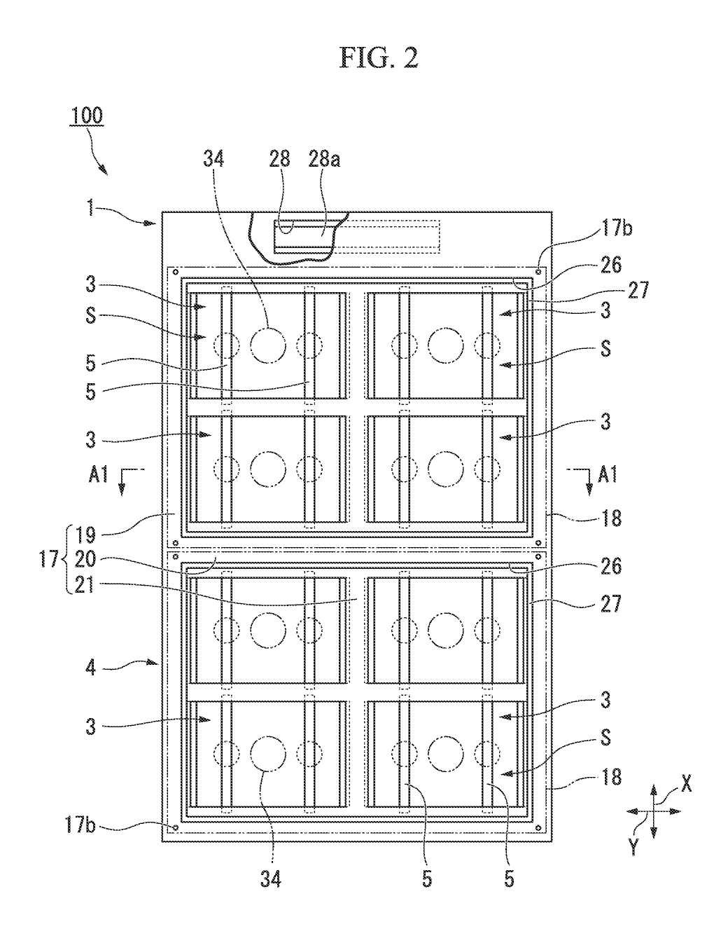

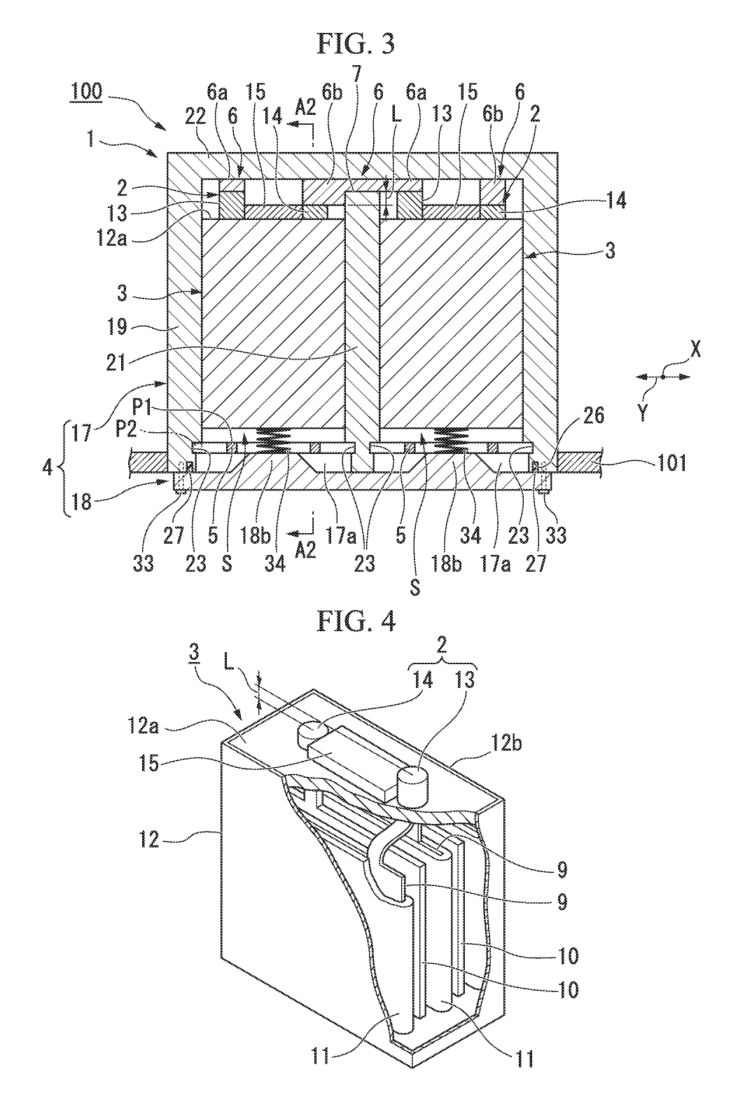

As shown in FIGS. 2 and 3, the battery device 1 includes a plurality of unit cells 3 having a pair of electrode terminals 2, a casing 4 that accommodates the unit cells 3, slide rails (temporary pressing portions) 5 that can support the unit cells 3, and bus bars (terminal connection members) 6 that electrically connect electrode terminals 2 of the unit cells 3 adjacent to each other.

In addition, in all drawings except for FIG. 4, the inner portions of the unit cells are shown in a simplified form.

As shown in FIG. 4, in the present embodiment, for example, a secondary battery such as a lithium ion secondary battery is used as the unit cell 3. An outline of the unit cell is formed in a rectangular parallelepiped shape and a plurality of electrode plates are configured so as to be laminated in the inner portion of the unit cell. Specifically, the unit cell 3 includes positive plates 9 and negative plates 10 that are alternately laminated, separators 11 that are interposed between the positive plates 9 and the negatives plates 10 respectively, a rectangular parallelepiped unit cell case 12 that accommodates the positive plates 9, the negative plates 10, and the separators 11, the above-described pair of electrodes terminals 2 that is connected to the positive plates 9 and the negative plates 10, and electrolyte (not shown) that is filled in the inner portion of the unit cell case 12.

The pair of electrode terminals 2 protrudes from upper surface (one end surface) 12a of the unit cell case 12. The pair of electrode terminals 2 includes a positive terminal 13 that is connected to the positive plates 9 and a negative terminal 14 that is connected to the negative plates 10. Lengths of the positive terminal 13 and the negative terminal 14 that protrude from the upper surface 12a are different from each other, and the length of the positive terminal 13 is longer than the length of the negative terminal 14 by a length L. A direction in which the positive terminal 13 and the negative terminal 14 are lined up is configured so as to be parallel to a long side 12b of the upper surface 12a.

A battery substrate 15 that detects a charging rate of the unit cell 3 or a potential difference between the positive terminal 13 and the negative terminal 14 is provided on the upper surface 12a.

In the unit cell 3 described as above, the electric energy is accumulated in the inner portion of the unit cell through the positive terminal 13 and the negative terminal 14 and the accumulated electric energy can be supplied to the outside through the positive terminal 13 and the negative terminal 14.

As shown in FIG. 2, in the present embodiment, the unit cells 3 are disposed in four rows in the forward and rearward direction X of the automobile 100 and in two rows in the left and right direction Y in the casing, and a total of eight unit cells can be accommodated. The unit cells 3 are accommodated in the inner portion of the casing 4 so that the pair of electrode terminals 2 faces upward and the long sides 12b of the upper surfaces 12a are parallel in the left and right direction Y.

In addition, for example, a weight of the unit cell for a general automobile is about several kilograms, and the total of the weights of eight unit cells becomes several tens of kilograms.

As shown in FIGS. 2 and 3, the casing 4 includes a casing main body 17 that is disposed upward and accommodates eight unit cells 3, and cover portions 18 that are mounted so as to be opened and closed to opening portions 17a for inserting the unit cells 3 to the inner portion of the casing main body 17 and that is formed in a plate shape. In addition, in FIG. 2, for convenience of explanation, the cover portions 18 are shown by two-dotted chain lines.

The casing main body 17 and the cover portions 18 are formed from a material that has insulation properties.

The casing main body 17 includes a side plate 19 that encloses the periphery in a rectangular shape, three front-rear partition plates 20 that partition the inner portion of the side plate 19 in the forward and rearward direction X, a left-right partition plate 21 that partitions the inner portion of the side plate 19 in the left and right direction Y, and a top plate 22 that closes the upper portion of the side plate 19, and the opening portions 17a are formed in the lower portion of the side plate 19. In addition, the side plate 19, the front-rear partition plate 20, the left-right plate 21, and the top plate 22 are formed so as to be integrated together.

In the inner portion of the casing main body 17, eight accommodation spaces S that accommodate one unit cell 3 in the inner portion respectively are formed by the front and rear partition plates 20 and the left and right partition plate 21. In addition, the opening portion 17a is formed for each accommodation space S.

In each accommodation space S, retraction grooves 23 that extend in the forward and rearward direction X are formed in the vicinity of the lower portions of the side plates 19 positioned at both sides in the left and right direction Y or the lower portion of the left and right partition plate 21.

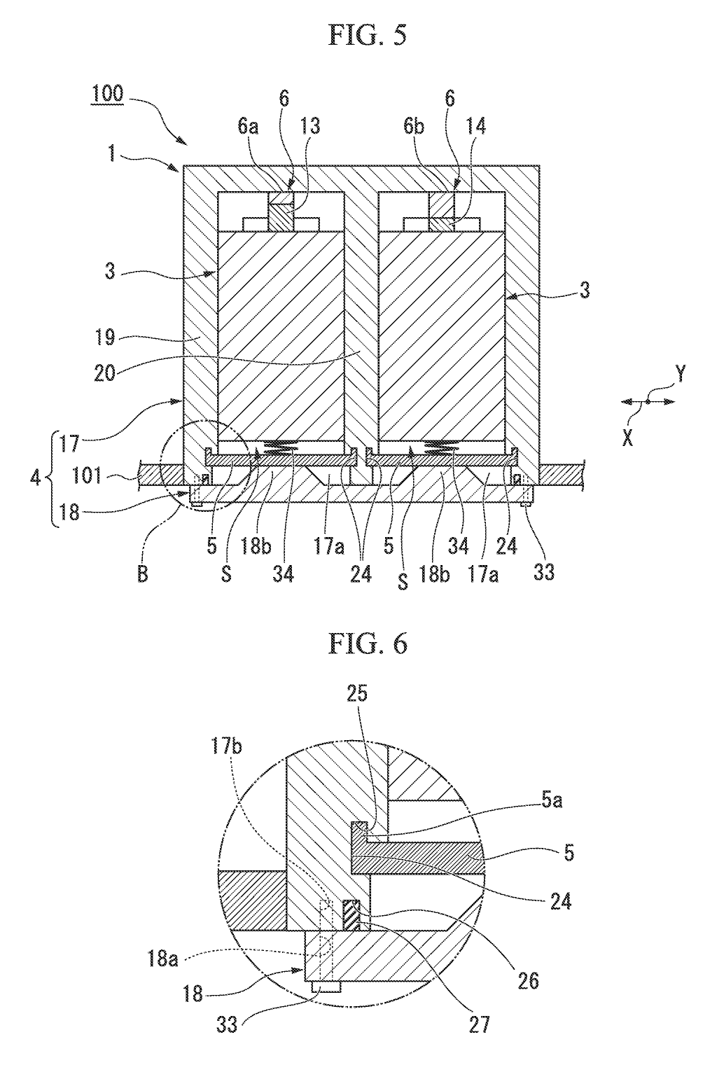

As shown in FIGS. 5 and 6, in each accommodation space S, guide grooves 24 that extend in the left and right direction Y are formed in the vicinity of the lower portion of the side plates 19 positioned at both sides in the forward and rearward direction X or the lower portions of the front and rear partition plates 20. Engagement grooves 25 that extend upward and extend so as to be parallel to the guide grooves 24 are formed in the guide grooves 24.

In addition, both ends of the guide grooves 24 are provided so as to be continuous to the retraction grooves 23.

In addition, as shown in FIGS. 2 and 3, in the vicinity of the edges of the casing main body 17 opposite to the cover portions 18, holding grooves 26 are formed at the lower portions of the side plates 19 so as to enclose a total of four accommodation spaces S of two rows in the forward and rearward direction X and two rows in the left and right direction Y. That is, in the present embodiment, the holding grooves 26 which are lined up in the forward and rearward direction X are formed at two places. A waterproofing packing 27 is mounted in each of the holding grooves 26.

In addition, an accommodation portion 28 having a predetermined size is formed at the front side of the casing main body 17, and a control portion 28a that controls the unit cells 3 is accommodated in the inner portion of the accommodation portion 28.

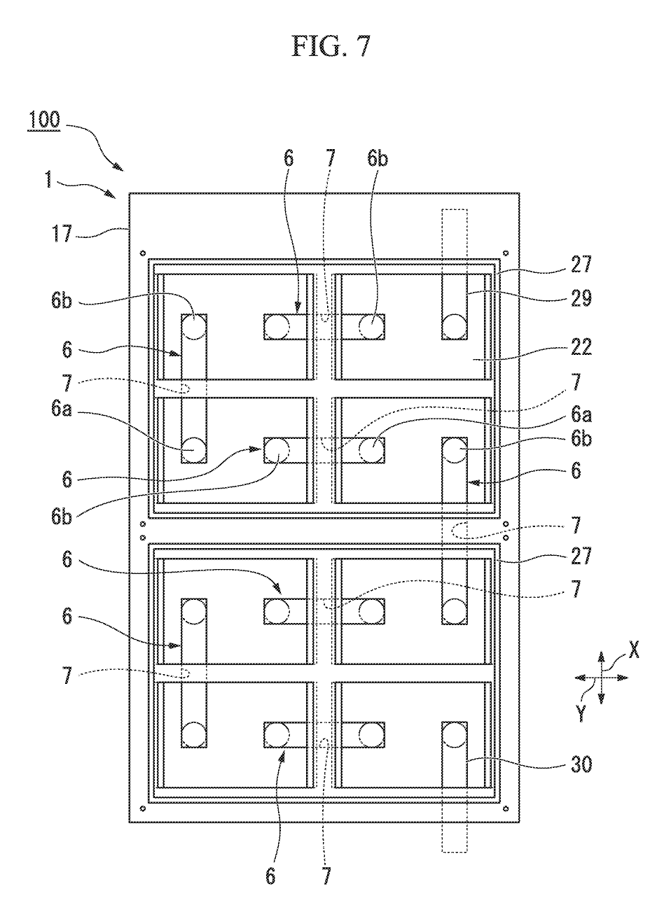

As shown in FIGS. 3 and 7, the bus bars 6 are formed in an approximately plate shape and are mounted in the inner surface of the top plate 22 of the casing main body 17. In addition, in FIG. 7, for convenience of explanation, the cover portions 18, the unit cells 3 and the slide rails 5 are not shown.

The bus bars 6 are formed of a conductor such as metal. In addition, in the bus bars 6, first ends 6a and second ends 6b are disposed above the accommodation spaces S adjacent to each other respectively, and are disposed in a state of being inserted to partition plate penetrating holes 7 that are formed in the front and rear partition plates 20 or the left and right partition plate 21.

The unit cells 3 are disposed in the inner portions of the accommodation spaces S so that the positive terminal 13 abuts the first end 6a of one bus bar 6 and the negative terminal 14 abuts the second end 6b of another bus bar 6 respectively. In addition, in the unit cells 3, as described above, since the positive terminals 13 are formed so as to be longer than the negative terminal 14 by L, the first ends 6a of the bus bars 6 are formed so as to be shorter than the second ends 6b in the up and down direction by length L which is equal to the length difference between the positive terminals 13 and the negative terminals 14. These bus bars 6 connect eight unit cells 3 in series. The positive terminals 13 of the unit cells 3 that are connected to the first ends 6a among eight unit cells 3 connected in series are connected to a first extraction member 29, and the negative terminals 14 of the unit cells 3 that are connected to the second ends 6b are connected to a second extraction member 30. Eight unit cells are electrically connected to one another, and therefore, configure an assembled battery.

The first extraction member 29 and the second extraction member 30 are formed of a conductor such as metal. The first extraction member 29 and the second extraction member 30 are electrically connected to the above-described motor and can supply the electric energy to the motor through eight unit cells 3 connected in series.

In addition, when the terminals 13 and 14 of the unit cells 3 abut the bus bars 6, the battery substrates 15 of the unit cells 3 are connected to the control portion 28a, and the unit cell cases 12 are configured so as to contact a temperature sensor (not shown). The temperature sensor is connected to the control portion 28a, and the control portion 28a can detect and control the potential differences between the terminals 13 and 14 of each unit cells 3 or the temperature of the unit cells 3.

As shown in FIGS. 2 and 3, two cover portions 18 are disposed so as to be lined up in the forward and rearward direction X.

The waterproofing packings 27 are configured so as to abut the marginal part of the top surface of each of the cover portions 18. A through hole 18a (refer to FIG. 6) is formed at each of four corners of the cover portions 18. In addition, a screw hole 17b corresponding to each of the through holes 18a is formed in the casing main body 17. Bolts 33 that are inserted into the through holes 18a are screwed to the screw holes 17b of the casing main body 17, and therefore, the cover portions 18 are mounted so as to be attachable to and detachable from the casing main body 17.

In the top surfaces of the cover portions 18, supporting portions 18b that are disposed in the vicinity of positions which are the center of each accommodation space S in a plan view and protrude upward are formed. That is, in each of the cover portions 18, a total of four supporting portions 18b of two rows in the forward and rearward direction X and two rows in the left and right direction Y are formed.

One end of battery biasing springs (battery biasing members) 34 that extend in a direction perpendicular to the cover portion 18 is fixed to the supporting portions 18b. When the cover portions 18 are mounted to the casing body 17, the battery biasing springs 34 bias the bottom surfaces of the unit cells 3 upward and make the terminals 13 and 14 abut the bus bars 6.

In addition, when the cover portions 18 are mounted to the casing body 17, the battery biasing springs 34 are interposed between the unit cells 3 and the cover portions 18, and it is preferable that the battery biasing springs 34 be set so as to be in a densely wound state in which the battery biasing springs 34 shrink and wires of the battery biasing springs 34 are in close contact in the up and down direction.

As shown in FIGS. 3 and 5, the slide rails 5 are formed in an approximately bar shape that extends in the forward and rearward direction X, and both ends of the slide rails 5 are engaged with the guide grooves 24. As shown in FIG. 6, engagement convex portions 5a that extend upward and are engaged with the engagement grooves 25 are provided at both ends of the slide rails 5. In addition, the slide rails 5 are of a size which can be accommodated in the inner portions of the retraction grooves 23. In addition, the engagement convex portions 5a that engage with the engagement grooves 25 have effects such as rotation prevention or slippage prevention of the slide rails 5 with respect to the casing main body 17.

The slide rails 5 have a strength that can support the unit cells 3 and are formed of a material having insulation properties. For example, as the slide rails 5, those can be used in which an insulation coating is performed on the surface of a steel material.

The slide rails 5 that are configured as described above move in the inner portions of the guide grooves 24 while the engagement convex portions 5a are engaged with the engagement grooves 25. Thereby, the slide rails 5 are slid in the left and right direction Y along the guide grooves 24 without coming off the guide grooves 24, and the slide rails 5 can move to a supporting position P1 (refer to FIG. 3) where they can support the unit cells 3 accommodated in the casing main body 17 and to a retreat position P2 in the retraction grooves 23 where the unit cells 3 can be inserted into and removed from the casing main body 17 through the opening portions 17a.

In addition, in the present embodiment, when the cover portion 18 is mounted to the casing main body 17, since the battery biasing springs 34 bias the unit cells 3 upward, a constant gap is formed between the bottom surfaces of the unit cells 3 and the slide rails 5.

Next, in the battery device 1 configured as described above, a procedure in which the unit cells 3 are exchanged will be described.

First, an operator removes the cover portions 18 from the casing main body 17 by removing bolts 33 from the state shown in FIG. 3. At this time, the unit cells 3 move downward due to their own weight. However, since the slide rails 5 are positioned at the supporting position P1 and support the bottom surfaces of the unit cells 3, the unit cells 3 do not drop downward from the casing main body 17. Thereby, the operator can remove the cover portions 18 with only a force capable of supporting the cover portions 18.

Subsequently, the operator moves the slide rails 5 from the supporting position P1 to the retreat position P2 along the guide grooves 24 while supporting the bottom surfaces of the unit cells 3 with one hand, and therefore, the unit cells 3 can pass through the opening portions 17a. At this state, the operator lowers the hand that supports the unit cells 3, and therefore, the unit cells 3 are lowered due to their own weight and are removed from the casing main body 17 through the opening portions 17a.

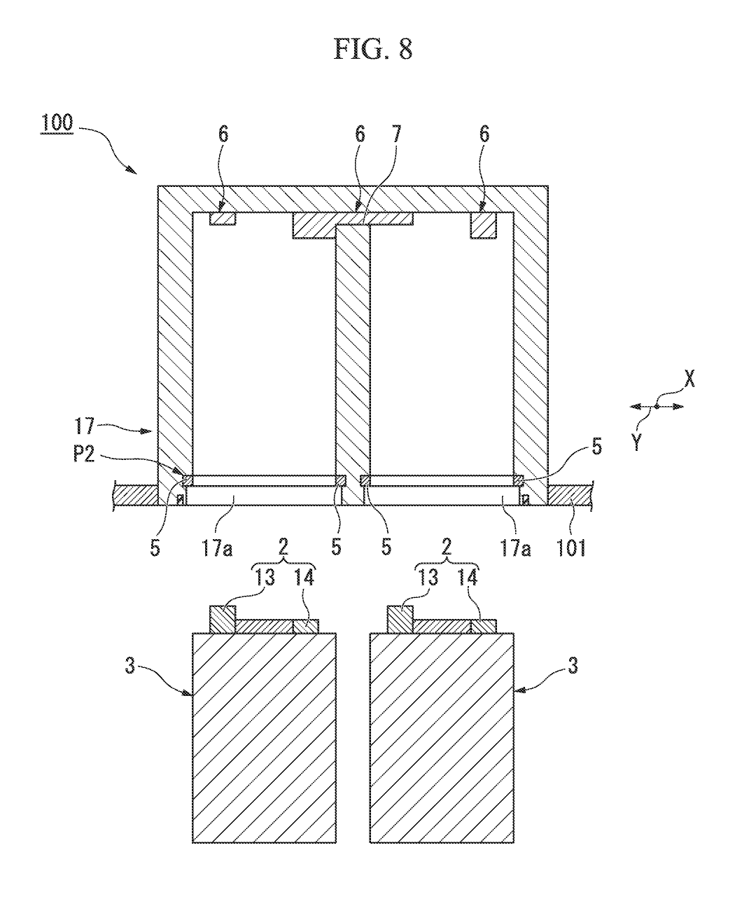

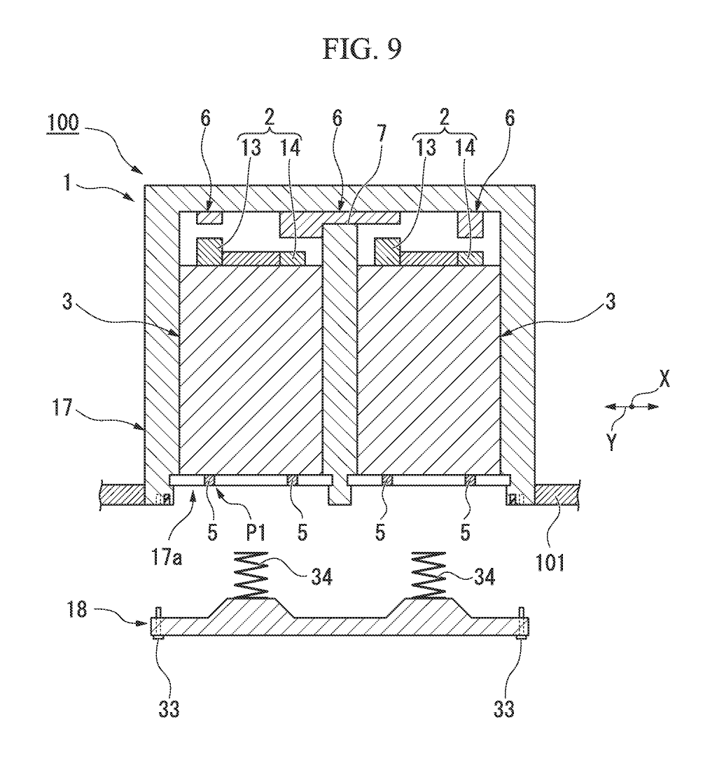

Next, as shown in FIG. 8, the operator inserts new unit cells 3 from the opening portions 17a into the casing main body 17 while making the pairs of electrode terminals 2 face upward. In addition, as shown in FIG. 9, the operator moves the slide rails 5 from the retreat position P2 to the supporting position P1 in a state of supporting the unit cells 3 with one hand. In this state, if the supporting of the unit cells 3 with one hand is ceased, the bottom surfaces of the unit cells 3 that are accommodated in the casing main body 17 are supported by the slide rails 5.

Next, the opening portions 17a are closed by the cover portions 18. At this time, the battery biasing springs 34 abut the bottom surfaces of the unit cells 3 and the battery biasing springs 34 are biased upward. Thereby, the unit cells 3 can be lifted up and abut the bus bars 6, the first extraction member 29, or the second extraction member 30. Thereafter, the cover portions 18 are fixed to the casing main body 17 by bolts 33, the unit cells 3 are supported by the cover portions 18 via the battery biasing springs 34, and a state where the pairs of electrode terminals 2 abut the bus bars 6, the first extraction member 29, or the second extraction member 30 is maintained.

As described above, according to the battery device 1 of the present embodiment, when the unit cells 3 are mounted to the casing main body 17, first, the unit cells 3 are inserted upward from the opening portions 17a that are formed in the lower portion of the casing main body 17 while the electrode terminals 2 face upward. Subsequently, since the unit cells 3 are supported by the slide rails 5, the state where the unit cells 3 are accommodated in the casing main body 17 can be held. At this time, the operator can accommodate the unit cells 3 in the casing main body 17 by supporting only the unit cells 3.

In addition, the opening portions 17a of the casing main body 17 are closed by the cover portions 18 while the unit cells 3 are biased upward by the battery biasing springs 34. Thereby, unlike the related art, without mounting or removing of the bus bars to the electrode terminals of the battery main body, the pairs of the electrode terminals 2 abut the bus bars 6 by the biasing forces of the battery biasing springs 34, and the electrode terminals 2 and the bus bars 6 can be reliably connected to each other.

On the other hand, when the unit cells 3 are removed from the casing main body 17, since the unit cells 3 are supported by the slide rails 5 even though the cover portions 18 are removed from the casing main body 17, the unit cells 3 do not drop downward. In addition, since the pairs of the electrode terminals 2 only abut the bus bars 6, the unit cells 3 can be removed from the casing main body 17 only by releasing the supported state by the slide rails 5.

Therefore, the unit cells 3 can be easily attached to and detached from the casing main body 17.

In addition, the slide rails 5 are provided so as to move to the supporting position P1 where they can support the unit cells 3 accommodated in the casing main body 17 and to the retreat position P2 where the unit cells 3 can be inserted into and removed from the casing main body 17 through the opening portions 17a. Thereby, when the slide rails 5 are disposed at the retreat position P2, the unit cells 3 can be easily inserted into and removed from the casing main body 17 through the opening portions 17a. On the other hand, when the slide rails 5 are disposed at the supporting position P1, it is possible to maintain the state where the unit cells 3 inserted into the casing main body 17 are accommodated in the casing main body 17.

In addition, in the present embodiment the positive terminals 13 and the negative terminals 14 have mutually different lengths that protrude from the upper surfaces 12a of the unit cell cases 12. In addition, the thicknesses of the first ends 6a and the second ends 6b of the bus bars 6 are set to be different from each other in the up and down direction so as to correspond to the lengths of the positive terminals 13 and the negative terminals 14 respectively.

Thereby, when the positions of the positive terminals 13 and the negative terminals 14 are exchanged and the unit cells 3 are accommodated in the casing main body 17, the positive terminals 13 that are longer than the negative terminals 14 abut the second ends 6b that are thicker than the first ends 6a in the up and down direction, and the negative terminals 14 are separated from the bus bars 6. Therefore, since the unit cells 3 cannot be inserted into the casing main body 17 up to a predetermined position, it is possible to prevent the unit cells 3 from being incorrectly mounted to the casing main body 17 in the state where the positions of the positive terminals 13 and the negative terminals 14 are exchanged.

In addition, the supporting portions 18b that protrude upward are formed on the cover portions 18, and one end of the battery biasing springs 34 is fixed to the supporting portions 18b. Thereby, lengths of the battery biasing springs 34 can be shortened, deformation amounts of the battery biasing spring 34 are suppressed, and therefore, the bottom surfaces of the unit cells 3 can be more reliably biased upward.

### Second Embodiment

Next, a second embodiment of the present invention will be described. Here, the same portions as the first embodiment are denoted by the same reference numerals, the descriptions thereof are omitted, and only different points will be described.

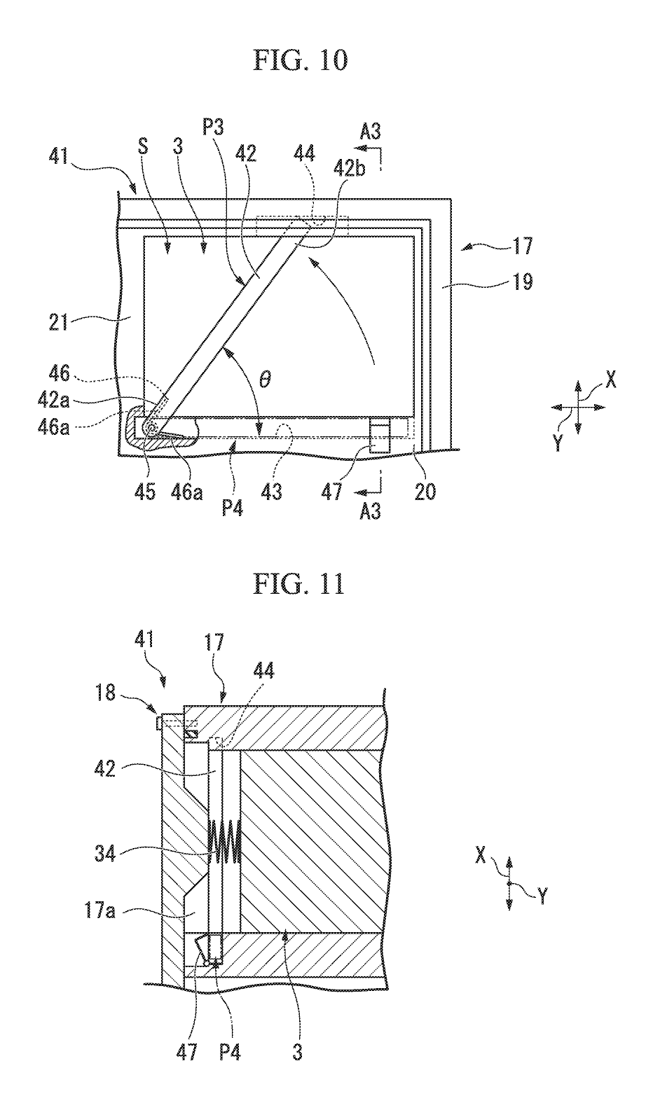

As shown in FIGS. 10 and 11, a battery device 41 of the present embodiment includes a rotating rail (temporary pressing portion) 42 and a rail biasing spring (pressing portion biasing member) 46 that biases the rotating rail 42 instead of the slide rail 5 of the battery device 1 of the first embodiment, and a retraction groove 43 and a locking groove 44 are formed instead of the retraction groove 23, the guide groove 24, and the engagement groove 25.

In addition, in FIG. 10, for convenience of explanation, the cover portion 18 is not shown.

The above-described retraction groove 43 is formed so as to extend in the left and right direction Y at the lower portion of the front and rear partition plate 20 that is positioned rearward or the side plate 19 in each accommodation space S. In addition, the above-described locking groove 44 is formed so as to extend in the left and right direction Y at the lower portion of the front and rear partition plate 20 that is positioned forward or the side plate 19 in each accommodation space S.

The rotating rail 42 is formed in an approximately bar shape and is of a size capable of being accommodated in the inner portion of the retraction groove 43. One end 42a of the rotating rail 42 is mounted so as to be rotated with respect to the casing main body 17 through a shaft member 45 in one end in the inner portion of the retraction groove 43. The above-described rail biasing spring 46 which is a torsion spring is supported by the shaft member 45. A pair of arm portions 46a of the rail biasing spring 46 is fixed to one end 42a of the rotating rail 42 and to the retraction groove 43 respectively.

As shown in FIG. 10, a position when the other end 42b of the rotating rail 42 is locked to the locking groove 44 is a supporting position P3 of the rotating rail 42. Even though the rotating rail 42 is positioned at the supporting position P3, the rail biasing spring 46 is set so that a force that increases an angle θ between the rotating rail 42 and the retraction groove 43 acts on the rotating rail 42 by the rail biasing spring 46.

In addition, a position of the rotating rail 42 when the rotating rail 42 is rotated about the shaft member 45 against the biasing force of the rail biasing spring 46 and is accommodated in the inner portion of the retraction groove 43 is a retreat position P4.

In the vicinity of the other end in the inner portion of the retraction groove 43, a hook 47 that holds the other end 42b of the rotating rail 42 that is disposed at the retreating position P4 is mounted.

In the battery device 41 of the present embodiment that is configured as described above, a procedure in which the unit cell 3 is exchanged is as follows.

First, the operator removes the cover portion 18 from the casing main body 17. In addition, the operator moves the rotating rail 42 from the supporting position P3 to the retreat position P4 against the biasing force of the rail biasing spring 46 in a state of supporting the unit cell 3 with one hand, and holds the other end 42b by a hook 47. In this state, the unit cell 3 is removed from the casing main body 17.

Next, the operator inserts a new unit cell 3 into the inner portion of the casing main body 17 and removes the hook 47 from the rotating rail 42 while supporting the bottom surface of the unit cell 3 with one hand. Thereby, the rotating rail 42 is rotated about the shaft member 45 by the biasing force of the rail biasing spring 46 and moves to the supporting position P3 in which the other end 42b is locked to the locking groove 44.

Therefore, the rotating rail 42 can support the bottom surface of the unit cell 3 from below.

In addition, the cover portion 18 is mounted to the casing main body 17 in a state where the other end of the battery biasing spring 34 abuts the bottom surface of the unit cell 3.

As described above, according to the battery device 41 of the present embodiment, the unit cell 3 is easily attached to and detached from the casing main body 17, and the electrode terminal 2 of the unit cell 3 can be reliably connected to the bus bar 6.

In addition, after the rotating rail 42 moves from the supporting position P3 up to the retreat position P4 against the biasing force of the rail biasing spring 46, the unit cell 3 is inserted into the casing main body 17 through the opening portion 17a. The unit cell 3 is accommodated in the casing main body 17, and since the rotating rail 42 returns to the supporting position P3 by the biasing force of the rail biasing spring 46 when the hook 47 is removed from the rotating rail 42, the unit cell 3 can be easily supported by the rotating rail 42.

In addition, in the present embodiment, without the rail biasing spring 46 and the hook 47, the operator may perform the movement of the rotating rail 42 between the supporting position P3 and the retreat position P4. According to this configuration, the configuration of the battery device 41 can be simplified.

### Third Embodiment

Next, a third embodiment of the present invention will be described. Here, the same portions as the above-described embodiments are denoted by the same reference numerals, the descriptions thereof are omitted, and only different points will be described.

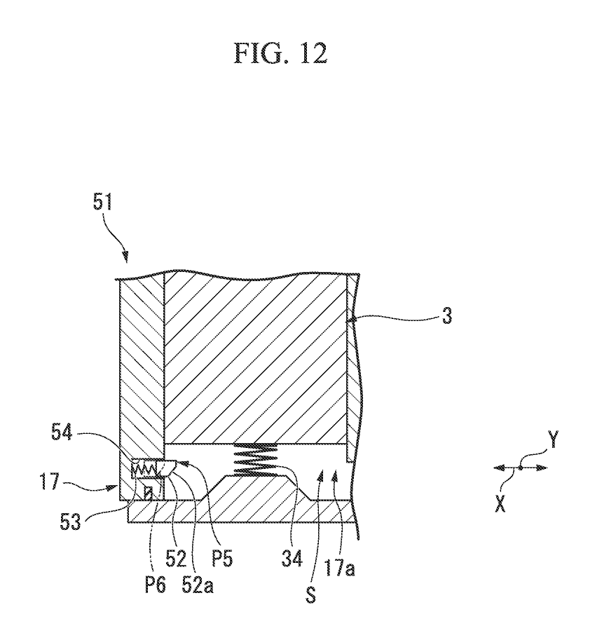

As shown in FIG. 12, a battery device 51 of the present embodiment includes a locking member (temporary pressing portion) 52 and a locking portion biasing spring (pressing portion biasing member) 53 that biases the locking member 52 instead of the slide rail 5 of the battery device 1 of the first embodiment, and a guide hole 54 is formed in the casing main body 17 instead of the retraction groove 23, the guide groove 24, and the engagement groove 25.

The guide hole 54 is formed so as to extend to be parallel in the forward and rearward direction X at the lower portion of the front and rear partition plate 20 that is positioned frontward or the side plate 19 in each accommodation space S. One end of the locking portion biasing spring 53 is connected to a wall surface of the guide hole 54, the other end is connected to the locking member 52, and the locking member 52 can be biased in a direction which is parallel to a horizontal plane.

The locking member 52 is formed so as to move only in the forward and rearward direction X due to the guide hole 54.

When the locking portion biasing spring 53 has a natural length, a portion of the tip side of the locking member 52 is configured so as to protrude to the inner portion of the accommodation space S, and the position of the locking member 52 at this time is a supporting position P5 at which the unit cell 3 can be supported.

In addition, the locking member 52 is biased to the locking portion biasing spring 53 side, the locking portion biasing spring 53 is shrunk, and therefore, the entire locking member 52 can be accommodated in the guide hole 54.

The position of the locking member 52 at this time is a retreat position P6 at which the unit cell 3 can be inserted into and removed from the casing main body 17.

In addition, in the tip side of the locking member 52, an inclined surface 52a that slides with the unit cell 3 and moves from the supporting position P5 side toward the retreat position P6 side as the unit cell 3 moves from the lower portion toward the upper portion is formed.

In the battery device 51 of the present embodiment that is configured as described above, a procedure in which the unit cell 3 is exchanged is as follows.

First, an operator removes the cover portion 18 from the casing main body 17. In addition, the operator maintains a state where the locking member 52 moves from the supporting position P5 to the retreat position P6 against the biasing force of the locking portion biasing spring 53 in a state where the unit cell 3 is supported by one hand of the operator.

In this state, the unit cell 3 is lowered and the unit cell 3 is removed from the casing main body 17. In the state where the unit cell 3 passes through the opening portion 17a, the locking member 52 cannot move toward the supporting position P5 due to the unit cell 3.

In addition, if the unit cell 3 is completely removed from the casing main body 17, the locking member 52 moves to the supporting position P5 due to the locking portion biasing spring 53.

Next, the operator inserts a new unit cell 3 into the inner portion of the casing main body 17. When the unit cell 3 is inserted, since the locking member 52 is positioned at the supporting position P5 by the biasing force of the locking portion biasing spring 53, the unit cell 3 abuts the inclined surface 52a of the locking member 52. In addition, as the unit cell 3 is inserted into the casing main body 17, since the unit cell 3 slides on the inclined surface 52a, the locking member 52 is pushed to the retreat position P6 side.

Thereby, the locking member 52 moves to the retreat position P6, and the unit cell 3 can be inserted into the casing main body 17.

When the position of the bottom surface of the unit cell 3 is inserted up to a position which is higher than the locking member 52, the locking member 52 moves to the supporting position P5 by the biasing force of the locking portion biasing spring 53. In this state, the operator ceases the supporting of the unit cell 3 with one hand, and the unit cell 3 is supported by the locking member 52.

Since the procedure after this is the same as that of the above-described embodiments, the description thereof is omitted.

According to the battery device 51 of the present embodiment that is configured as described above, the unit cell 3 is easily attached to and detached from the casing main body 17, and the electrode terminal 2 of the unit cell 3 can be reliably connected to the bus bar 6.

In addition, when the unit cell 3 is inserted into the casing main body 17 through the opening portion 17a, the unit cell 3 abuts the inclined surface 52a and is inserted while sliding, and therefore, the locking member 52 can move from the supporting position P5 to the retreat position P6. Thereby, the locking member 52 moves to the retreat position P6 only by inserting and operating the unit cell 3 and the casing main body 17 can accommodate the unit cell 3, and the unit cell 3 can be supported by the locking member 52 in the state where the unit cell 3 is accommodated in the casing main body 17.

As above, the first to third embodiments of the present invention are described with reference to the drawings. However, the specific configurations are not limited to the embodiments and include modifications or the like of the configuration within the scope which does not depart from the gist of the present invention.

In the first to third embodiments, in the length which protrudes from the upper surface 12a of the unit cell 3, the positive terminal 13 and the negative terminal 14 are different from each other, and therefore, it is possible to prevent the unit cells 3 from being incorrectly mounted to the casing main body 17 in the state where the positions of the positive terminal 13 and the negative terminal 14 are exchanged. However, the method for preventing the false mounting of the unit cell 3 is not limited thereto.

For example, in the length of the electrode terminal 2 that protrudes from the upper surface 12a of the unit cell case 12, the negative terminal 14 may be formed so as to be longer than the positive terminal 13 by the length L.

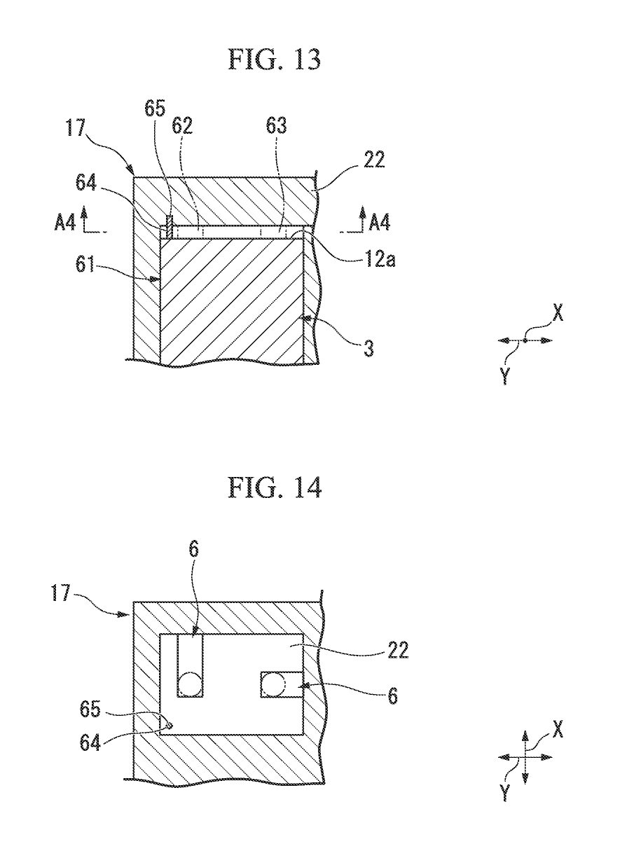

In addition, as shown in FIGS. 13 and 14, the lengths of the positive terminal 62 and the negative terminal 63 of the unit cell 61 that protrude from the upper surface 12a are set to be equal to each other, a protrusion 64 that is formed so as to protrude from the upper surface 12a of the unit cell 61 is provided, and a recessed portion 65 may be formed in which the protrusion 64 is inserted on the inner surface of the top plate 22 of the casing main body 17.

Since the protrusion 64 is formed on the upper surface 12a of the unit cell 61 and the recessed portion 65 is formed on the inner surface of the top plate 22 of the casing main body 17, when the unit cell 61 is accommodated in the casing main body 17 in the state where the positions of the positive terminal 62 and the negative terminal 63 are exchanged, the protrusion 64 of the unit cell 61 abuts the inner surface of the top plate 22 of the casing main body 17, and the unit cell 61 cannot be inserted up to a predetermined position in the inner portion of the casing main body 17.

Therefore, it is possible to prevent the unit cell 61 from being incorrectly mounted to the casing main body 17 in the state where the positions of the positive terminal 62 and the negative terminal 63 are exchanged.

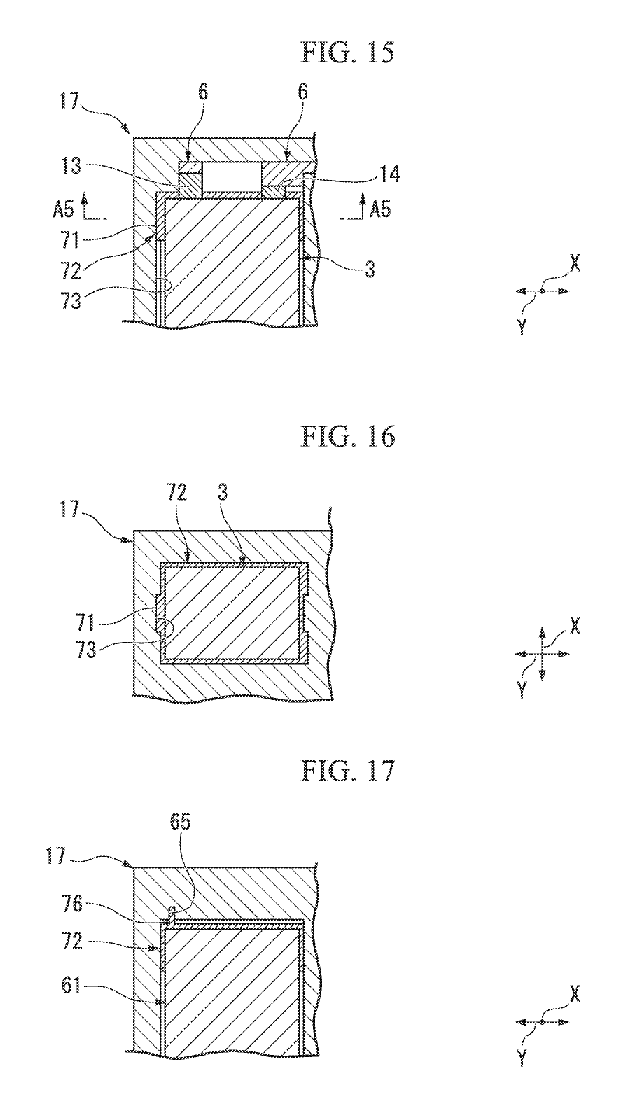

In addition, as shown in FIGS. 15 and 16, a cover member 72 that is fitted to the unit cell 3 and includes a convex portion 71 which protrudes from the side surface of the unit cell 3 is provided, and a groove portion 73 which engages with the convex portion 71 of the unit cell 3 accommodated in the inner portion and along which the unit cell 3 can move up and down may be formed on the inner circumferential surface of the casing main body 17.

With this configuration, when the unit cell 3 is inserted into the casing main body 17 in a direction different from a general insertion direction, since the convex portion 71 included in the cover member 72 abuts the casing main body 17, the unit cell 3 cannot be inserted up to a predetermined position in the inner portion of the casing main body 17. Therefore, it is possible to prevent the unit cell 3 from being incorrectly mounted to the casing main body 17 in the direction different from the general insertion direction.

In addition, since the convex portion 71 is formed on the cover member 72, the shape of the cover member that is fitted to the unit cell 3 may be changed even when the shapes of the unit cells 3 are the same as one another, which can correspond to various shapes of the groove portion 73.

In addition, as shown in FIG. 17, a protrusion 76 having the same shape as that of the protrusion 64 of the modification is formed in the cover member 72, and the above-described recessed portion 65 into which the protrusion 76 is inserted may be formed on the inner surface of the top plate 22 of the casing main body 17.

In addition, in the above-described embodiments, a total of eight unit cells 3 of four rows in the forward and rearward direction X and two rows in the left and right direction Y are accommodated in the casing main body 17. However, the number of the unit cells 3 that are accommodated in the casing is not limited and it is no matter how many unit cells 3 are used. However, it is preferable that the first extraction member 29 and the second extraction member 30 which supply the electric energy from the casing to the outside be disposed at a position at which the both members are close to each other.

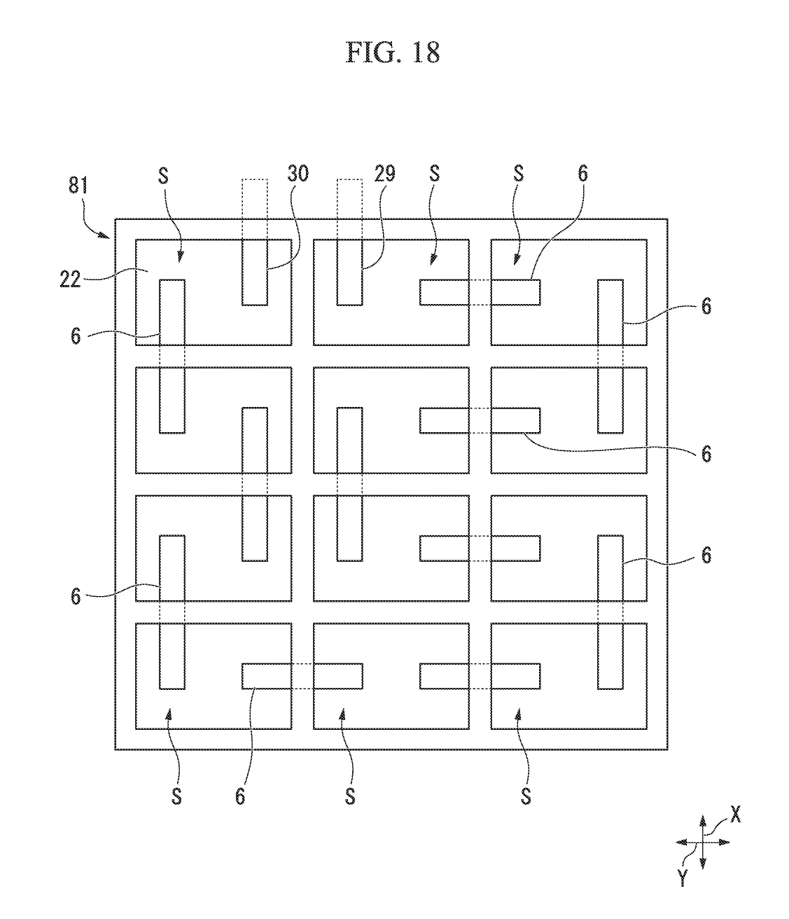

For example, as shown in FIG. 18, when a total of twelve accommodation spaces S of four rows in the forward and rearward direction X and three rows in the left and right direction Y, in which unit cells 3 are accommodated, is formed in the casing main body 81, the bus bars 6 are disposed on the top plate 22 as shown in FIG. 18, and the first extraction members 29 and the second extraction members 30 are made to be close to each other.

Since the extraction members 29 and 30 are disposed in this way, the configurations of the seal members (not shown) that are disposed in the peripheries of the extraction members 29 and 30 can be simplified.

In addition, when the unit cell is a dry type battery, the unit cell may be accommodated in the casing main body so that electrode terminals face downward.

### INDUSTRIAL APPLICABILITY

The present invention relates to a battery device that includes a plurality of unit cells that include a pair of electrode terminals that protrudes from one end surface; a casing main body that includes an opening portion that is formed in a lower portion and a top plate that closes an upper portion, and that accommodates insertion of the unit cells from the opening portion while the pair of electrode terminals faces upward; a temporary pressing portion that can support the unit cells in a state where the unit cells are accommodated in a casing main body; a terminal connection member that is provided in an inner surface of the top plate, abuts the pair of electrode terminals of the unit cell that is accommodated in the casing main body, and electrically connects the electrode terminals of the unit cells adjacent to each other; and a cover portion that includes a battery biasing member that biases the unit cell upward in a state where the opening portion is closed and makes the electrode terminals abut the terminal connection member, and that is provided so as to be opened and closed in the opening portion.

According to the present invention, the unit cell can be easily attached and detached, and the electrode terminals of the unit cell can be reliably connected to the terminal connection member.

### DESCRIPTION OF REFERENCE NUMERALS

1, 41, and 51: battery device
2: electrode terminal
3 and 61: unit cell
5: slide rail (temporary pressing portion)
5a: engagement convex portion
6: bus bar (terminal connection member)
7: partition plate penetrating hole
9: positive plate
10: negative plate
11: separator
12: unit cell case
12a: upper surface (one end surface)
12b: long side
13 and 62: positive terminal
14 and 63: negative terminal
17 and 81: casing main body
17a: opening portion
17b: screw hole
18: cover portion
18a: through hole
19: side plate
20: front and rear partition plate
21: left and right partition plate
22: top plate
23 and 43: retraction groove
24: guide groove
25: engagement groove
26: holding groove
27: waterproofing packing
28: accommodation portion
28a: control portion
29: first extraction member
30: second extraction member
33: bolt
34: battery biasing spring (battery biasing member)
42: rotating rail (temporary pressing portion)
42a: one end
42: the other end
44: locking groove
45: shaft member
46: rail biasing spring (pressing portion biasing member)
46a: arm portion
47: hook
52: locking member (temporary pressing portion)
52a: inclined surface
53: locking portion biasing spring (pressing portion biasing member)
54: guide hole
64 and 76: protrusion
65: recessed portion
71: convex portion
72: cover member
73: groove portion
100: automobile
101: undercarriage
102: wheel
P1, P3, and P5: supporting position
P2, P4, and P6: retreat position

1-7. (canceled)

8. A battery device comprising:
a plurality of unit cells that include a pair of electrode terminals that protrudes from one end surface;
a casing main body that includes an opening portion that is formed in a lower portion and a top plate that closes an upper portion, and that accommodates insertion of the unit cells from the opening portion while the pair of electrode terminals faces upward;
a temporary pressing portion that can support the unit cells in a state where the unit cells are accommodated in the casing main body;
a terminal connection member that is provided on an inner surface of the top plate, abuts the pair of electrode terminals of the unit cell that is accommodated in the casing main body, and electrically connects the electrode terminals of the unit cells adjacent to each other; and
a cover portion that includes a battery biasing member that biases the unit cell upward in a state where the opening portion is closed and makes the electrode terminals abut the terminal connection member, and that is provided so as to be opened and closed in the opening portion.

9. The battery device according to claim 8,
wherein the temporary pressing portion is provided so as to move to a supporting position that can support the unit cell accommodated in the casing main body and a retreat position at which the unit cell can be inserted into and removed from the casing main body through the opening portion.

10. The battery device according to claim 9,
wherein the casing main body further includes a pressing portion biasing member that biases the temporary pressing portion to be disposed at the supporting position.

11. The battery device according to claim 10,
wherein the temporary pressing portion includes an inclined surface that is formed so to move from the supporting position side toward the retreat position side as the unit cell moves from the lower portion toward the upper portion.

12. The battery device according to claim 8,
wherein the pair of electrode terminals has mutually different lengths that protrude from the one end surface of the unit cell.

13. The battery device according to claim 9,
wherein the pair of electrode terminals has mutually different lengths that protrude from the one end surface of the unit cell.

14. The battery device according to claim 10,
wherein the pair of electrode terminals has mutually different lengths that protrude from the one end surface of the unit cell.

15. The battery device according to 11,
wherein the pair of electrode terminals has mutually different lengths that protrude from the one end surface of the unit cell.

16. The battery device according to claim 8,
wherein a protrusion that is provided so as to protrude from the one end surface is formed, and
a recessed portion into which the protrusion is inserted is formed in an inner surface of the top plate of the casing main body.

17. The battery device according to claim 9,
wherein a protrusion that is provided so as to protrude from the one end surface is formed, and
a recessed portion into which the protrusion is inserted is formed in an inner surface of the top plate of the casing main body.

18. The battery device according to claim 10,
wherein a protrusion that is provided so as to protrude from the one end surface is formed, and
a recessed portion into which the protrusion is inserted is formed in an inner surface of the top plate of the casing main body.

19. The battery device according to claim 11,
wherein a protrusion that is provided so as to protrude from the one end surface is formed, and
a recessed portion into which the protrusion is inserted is formed in an inner surface of the top plate of the casing main body.

20. The battery device according to claim 8, further comprising:
a cover member that is fitted to the unit cell and includes a convex portion that protrudes from a side surface of the unit cell,
wherein a groove portion that engages with the convex portion of the unit cell accommodated in the inner portion of the casing main body and can move up and down is formed in an inner circumferential surface of the casing main body.

21. The battery device according to claim 9, further comprising:
a cover member that is fitted to the unit cell and includes a convex portion that protrudes from a side surface of the unit cell,
wherein a groove portion that engages with the convex portion of the unit cell accommodated in the inner portion of the casing main body and can move up and down is formed in an inner circumferential surface of the casing main body.

22. The battery device according to claim 10, further comprising:
a cover member that is fitted to the unit cell and includes a convex portion that protrudes from a side surface of the unit cell,
wherein a groove portion that engages with the convex portion of the unit cell accommodated in the inner portion of the casing main body and can move up and down is formed in an inner circumferential surface of the casing main body.

23. The battery device according to claim 11, further comprising:
a cover member that is fitted to the unit cell and includes a convex portion that protrudes from a side surface of the unit cell,
wherein a groove portion that engages with the convex portion of the unit cell accommodated in the inner portion of the casing main body and can move up and down is formed in an inner circumferential surface of the casing main body.
